(19) United States
(12) Patent Application Publication
(10) Pub. No.: US 2008/0276781 A1
(43) Pub. Date: Nov. 13, 2008

(54) Cutting tool

(75) Inventors: Franz Egger, Vomp (AT); Karl Zepic, Pfons (AT)

Correspondence Address: WENDEROTH, LIND & PONACK, L.L.P., 2033 K STREET N. W., SUITE 800, WASHINGTON, DC, 20006-1021, US

(73) Assignee: Tyrolit Schleifmittelwerke Swarovski K.G.

(21) Appl. No.: 12/216,605

(22) Filed: Jul. 8, 2008

Related U.S. Application Data
(63) Continuation of application No. PCT/AT2007/000061, filed on Feb. 6, 2007.

(30) Foreign Application Priority Data
Feb. 16, 2006 (EP) 06 003 107.7

(51) Int. Cl. B26D 1/46; B27B 13/00

(52) U.S. Cl. 83/661; 83/835

(57) ABSTRACT

Cutting tool having a support and a multiplicity of saw teeth which have a tip region and a root region, wherein the saw teeth are welded directly or indirectly to the support at the root region, and wherein the tip region is narrower than the root region in side view.

The invention concerns a cutting tool comprising a carrier and a plurality of saw teeth which have a tip region and a root region, wherein the saw teeth are directly or indirectly welded to the carrier at the root region.

Cutting tools of the general kind set forth in the form of band saws are known for example from WO 03/059562 A1. Cutting tools of that kind are used for example in processing rocks and stones, wherein the saw teeth of such cutting tools have different cutting properties for example by virtue of coatings on the grinding or cutting segments and can advantageously be adapted to the material to be cut.

To be able to exert a high cutting pressure with conventional, substantially rectangular saw teeth, the application of a high level of force is required on the part of the sawing machine. Attempts to narrow the saw teeth in order to achieve a higher cutting pressure with the same application of force by the sawing machine and thus to increase the advance rate have had the result that saw teeth have individually broken off the carrier.

Therefore the object of the present invention is to develop a cutting tool of the general kind set forth, in which in the cutting operation on the saw tooth a higher cutting pressure and thus a greater advance rate can be achieved without individual cutting teeth breaking off the carrier.

According to the invention that is achieved in that the saw teeth have a tip region and a root region, wherein in a side view the tip region is narrower in a side view than the root region.

The combination of a wide root region with a narrow tip region ensures on the one hand that the saw teeth have a high level of stability in respect of rupture with at the same time an increased cutting pressure. In addition the amount of material involved in each saw tooth is reduced, thus reducing production costs.

In that respect it has proven to be desirable for cutting rocks and stones if the upper edge of the tip region is substantially parallel to the lower edge of the root region. In the simplest case therefore the upper edge of the tip region will also be parallel to the cutting or running direction of the cutting tool, which makes it possible for the cutting tool to be used in both possible running directions.

In a particularly preferred variant it is provided that the tip region and the root region form an L-shape in side view. Such an L-shape ensures a high advance rate and a clean cutting guidance effect with very good stability in respect of the saw tooth. In addition the rise in temperature of such a saw tooth is reduced in comparison with the state of the art with rectangular saw teeth. In the variant in which the tip region and the root region of the saw tooth form an L-shape in side view it has proven to be advantageous if the L-shaped saw teeth face in opposite relationship to the running direction of the cutting tool. In other words, in the preferred situation, the long lateral edge of the saw tooth is to face in the cutting direction.

Another variant provides that the tip region and the root region form an inverted T in side view. With such a configuration for the saw tooth the cutting tool can be used in both cutting directions without the cutting properties changing upon a change in the cutting direction.

Experiments have shown that the cutting tool or the cutting teeth adhere particularly well to the carrier and at the same time have an ideal cutting efficiency when the ratio of the width of the tip region to the width of the root region is 0.8 to 0.4, preferably 0.7 to 0.5, particularly preferably about 0.6. In a preferred variant it has proven advantageous if the ratio of the width of the tip region to the height of the tip region is about 1:1. It is further advantageous if the ratio of the width of the root region to the total height of the saw tooth is between 2:1 and 1:2. The actual width of the tip region in preferred variants is less than 15 mm, particularly preferably between 8 and 12 mm.

So that the wear phenomena at the saw tooth or the cutting tool are comparatively low and so that the rise in temperature of the saw tooth or the cutting tool in operation is also as low as possible it has proven advantageous if the thickness of the saw tooth in the root region is less than the thickness in the tip region.

In that respect investigations have shown that it is particularly desirable if the ratio of the thickness in the tip region to the width of the saw teeth is between 1:4 and 1:2.

In alternative variants it can certainly be provided that the upper edge in the tip region has a curvature. Such a variant is used when the material to be cut requires it.

As a further consequence it is also possible that the upper edge in the tip region is bevelled at least region-wise. Such variants are also adopted in dependence on the material to be cut.

To maximise the durability of the cutting tool it has proven to be advantageous if the carrier has a coating. Such coatings ward off the adverse influences due to a coolant and due to aggressive stone and rock slurries when cutting rock and stone and thus prolong the durability of the cutting tool. In that respect in the simplest case it can be provided that the coating is a galvanisation. It is preferably provided that the coating material has material powder for improving durability and that the coating has SnZnCo, CuSnZn and/or matt nickel.

To still further increase the strength of the teeth and to reduce the probability of a saw tooth breaking off during a cutting operation it has also proven to be advantageous if intermediate portions are introduced between the saw teeth and the carrier, which intermediate portions are so adapted that they permit sintering to the actual saw tooth and at the same time favour welding to the carrier.

Further advantages and details of the invention will be described with reference to the Figures and the specific description by means of advantageous embodiments by way of example. In the drawings:

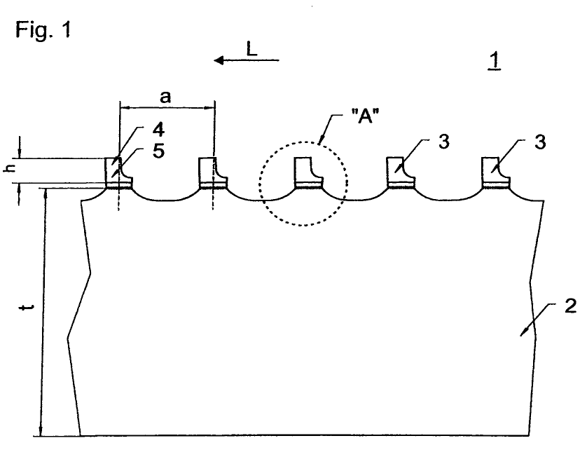

FIG. 1 shows a diagrammatic side view of a cutting tool according to the invention,

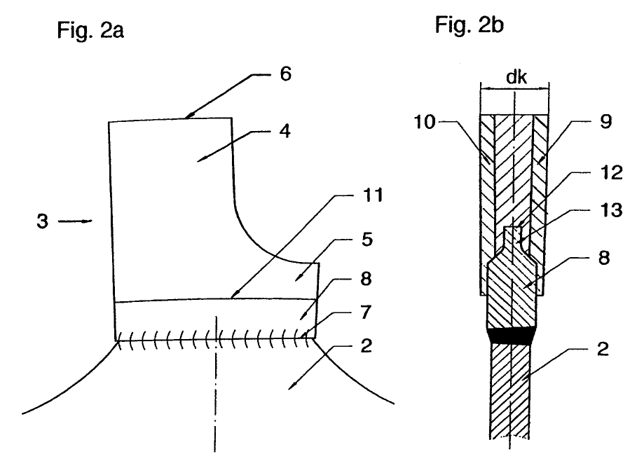

FIG. 2 shows a detail view of FIG. 1 as a side view (FIG. 2a) and in cross-section (FIG. 2b),

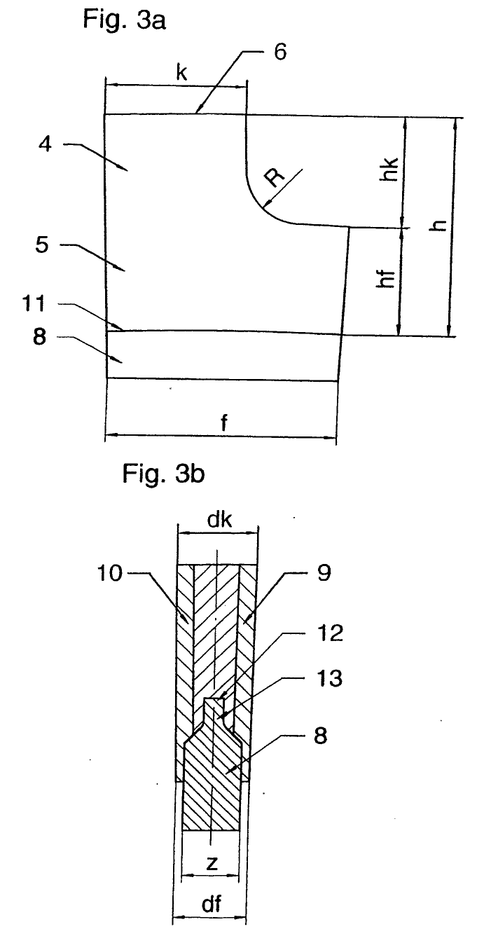

FIG. 3 shows a further variant of a saw tooth with an intermediate portion as a side view (FIG. 3a) and as a cross-section (FIG. 3b), and

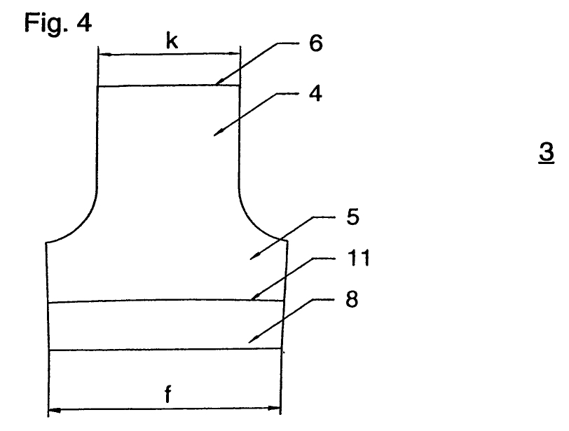

FIG. 4 shows a further variant of a saw tooth according to the invention.

FIG. 1 shows a cutting tool 1 in the form of a saw band with a carrier 2 and a plurality of saw teeth 3, wherein the saw teeth 3 have a tip region 4 and a root region 5 and wherein the saw teeth 3 are welded to the carrier 2 at the root region 5 by way of an intermediate portion 8. In this case the tip region 4 is narrower than the root region 5. The illustrated embodiment shows a saw band, in which respect it will be appreciated that circular saw blades, annular bits and so forth are also provided in accordance with the invention. The term annular bits is used to denote cutting tools 1 having a cylindrical carrier 2 on which the saw tooth 3 are mounted like battlements on a tower. In the present embodiment the saw tooth 3 were firstly fitted on to the intermediate portion 8 and then sintered thereon and the intermediate portion 8 was then welded on to the carrier 2. The carrier 2 can comprise for example 48CrMoV67 and the intermediate portions for example 25CrMo4. The grinding segments 9, 10 of the saw tooth 3 can have a higher concentration of cutting means, in which respect for example the use of diamond grain is suitable as a cutting means. In that respect a mixture which contains at least two of the elements iron, cobalt, copper, tungsten, tin and nickel has proven its worth as a sintered bond. It is desirable in that respect if the saw teeth contain sinterable binding agents so that the cutting teeth 3 can be sintered on to the intermediate portions 8 in a simple fashion, in per se known manner. In FIG. 1 the preferred running direction of the cutting tool is indicated by the reference ‘L’. It will therefore be seen that the approximately L-shaped saw teeth (in side view) are oriented with their long side edge in the cutting or running direction. In the present embodiment the height of the carrier 2 is about 80 mm, the spacing a between two saw teeth 3 in this embodiment is about 28 mm and the total height of a saw tooth plus intermediate segment is about 1 cm. It will be appreciated that this is only a variant which has proven to be desirable and appropriate for certain materials to be cut. In itself the spacing at which the saw teeth 3 are arranged relative to each other and the precise dimensions they involve can be left to the man skilled in the art.

FIG. 2a shows the portion ‘A’ in FIG. 1 once again in greater detail. In this case it is possible to see the upper edge 6 of the tip region 4, which is substantially parallel to the lower edge 11 of the root region 5. In this case the edge is also parallel to the running direction L of the cutting tool 1. It is also possible to clearly see the weld seam 7 between the carrier 2 and the intermediate segment 8. In the cross-sectional view (FIG. 2b) of the view A it is also possible to see the precise structure of the saw tooth 3. In this case the saw tooth 3 is fitted on to the intermediate segment 8 and sintered thereon, the intermediate segment 8 being welded to the carrier 2. The saw tooth 3 has laterally arranged grinding segments 9, 10. The saw tooth 3 becomes wider towards the tip region 4 to permit a more stable cut in operation. The groove-shaped recess 12 in the saw tooth 3 and the tongue-like projection 13 of the intermediate segment 8, which extends into the saw tooth 3, provides an even better hold for the saw tooth 3 on the intermediate segment 8.

FIG. 3a shows a further variant of an approximately L-shaped saw tooth 3, wherein the height hk of the tip region 4 is approximately equal to the height hf of the root segment 5. It should be noted at this juncture that the same references are used in all Figures, and for that reason each reference will no longer be discussed in detail here. In comparison with the variant in FIG. 2 where the height hk of the tip region 4 was somewhat less than the height hf of the root region 5, the configuration of FIG. 3 is particularly desirable if very hard materials are to be cut with the cutting tool 1. It will also be seen that the saw tooth 3 becomes conically wider upwardly, that is to say the width f of the root region 5 is not the location involving the greatest width of the saw tooth 3 but, as shown here, along the edge B, that is to say at the upper side of the root region 5. It is desirable if the boundary between the tip region 4 and the root region 5 is rounded at the radius R, wherein the size of R depends on the notch loading and is here at least 1 mm. In the section (FIG. 3b) through the saw tooth 3 with intermediate segment 8 it is also possible to see that the thickness df of the root region 5 is less than the thickness dk of the tip region 4 and the intermediate segment 8 is of an even smaller thickness z. The upwardly increasing thickness of the saw tooth 3 is achieved by the angle α, that is to say the angle between the side edge of a grinding segment 9, 10 and the upper edge 6 in the cross-section, being below 90°, for example being about 89°.

FIG. 4 shows a further variant of a saw tooth 3 according to the invention, in which case the tip region 4 with the root region 5 forms an inverted T. Such a saw tooth 3 is desirable when the cutting tool 1 is to be used in both running directions K.

For securely connecting the intermediate portions 8 to the carrier 2 it is preferably provided that the intermediate portions 8 are welded to the carrier 2 by laser welding. In the case of a variant in the form of a band saw as the cutting tool 1 it is desirable for optimum grinding efficiency if the carrier band 2 has between 25 and 45, preferably about 35 saw teeth 3, per running metre. Optimum flexing and strength properties are achieved by the carrier band 2 being of a thickness of between 0.9 mm and 2.2 mm, preferably about 1.65 mm. In particular 48CrMoV67 has proven its worth as the steel, as the material for the carrier 2. If the intermediate portions 8 comprise a steel with a carbon content of less than 0.35% or a carbon equivalent of less than 0.75%, in particular St52 or 25CrMo4, that ensures good weldability of intermediate portions 8 and carrier 2. In order not to impede the movement of the band saw around rollers of the band saw machine, it is preferably provided that the saw teeth 3 are of a height h of between 8 mm and 15 mm, preferably about 10.5 mm. The necessary hardness of the grinding segments 9, 10 which is required for use in stone or rock is achieved by the use of diamond grain as the cutting means. In that respect a mixture which contains at least two of the elements iron, cobalt, copper, tungsten, tin and nickel has proven its worth as the sintering bond. The band saw shown in FIG. 1 has a carrier 1 which comprises 48CrMoV67. The carbon equivalent which is calculated in accordance with the formula Cₑ=C+(Mn/6)+(Cr/5)+(Ni/15)+(Mo/4) is thus over 0.95%. The height of the carrier band 1 is about 80 mm and the thickness about 1.65 mm.

1. A cutting tool comprising a carrier and a plurality of saw teeth which have a tip region and a root region, wherein the saw teeth are welded to the carrier at the root region, wherein in a side view the tip region is narrower than the root region.

2. A cutting tool according to claim 1, wherein the upper edge of the tip region is substantially parallel to the lower edge of the root region.

3. A cutting tool according to claim 1, wherein the tip region and the root region form an L-shape in side view.

4. A cutting tool according to claim 1, wherein the tip region and the root region form an inverted T in side view.

5. A cutting tool according to claim 1, wherein the ratio of the width of the tip region to the width of the root region is 0.8 to 0.4.

6. A cutting tool according to claim 1, wherein the ratio of the width of the tip region to the height of the tip region is about 1:1.

7. A cutting tool according to claim 1, wherein the ratio of the width of the root region to the total height of the saw tooth is between 2:1 and 1:2.

8. A cutting tool according to claim 1, wherein the thickness of the saw tooth in the root region is less than the thickness in the tip region.

9. A cutting tool according to claim 1, wherein the ratio of the thickness in the tip region to the width of the saw teeth is between 1:4 and 1:2.

10. A cutting tool according to claim 1, wherein the upper edge in the tip region has a curvature.

11. A cutting tool according to claim 1, wherein the upper edge in the tip region is bevelled at least region-wise.

12. A cutting tool according to claim 1, wherein the carrier has a coating.

13. A cutting tool according to claim 12, wherein the coating is a galvanisation.

14. A cutting tool according to claim 12, wherein the coating comprises SnZnCo, CuSnZn and/or matt nickel.

15. A cutting tool according to claim 1, wherein intermediate portions are introduced between the saw teeth and the carrier.
